(19) United States
(12) Patent Application Publication
(10) Pub. No.: US 2015/0105056 A1
(43) Pub. Date: Apr. 16, 2015

(54) METHODS AND DEVICES FOR ESTABLISHING CALL

(71) Applicant: Xiaomi Inc., Beijing (CN)

(72) Inventors: Wenlin Wang, Beijing (CN); Zhongliang Qiao, Beijing (CN); Xinyu Liu, Beijing (CN)

(21) Appl. No.: 14/574,400

(22) Filed: Dec. 18, 2014

Related U.S. Application Data
(63) Continuation-in-part of application No. PCT/CN2013/083990, filed on Sep. 23, 2013.

(30) Foreign Application Priority Data
Oct. 29, 2012 (CN) 201210422368.8

(51) Int. Cl. H04M 7/12; H04L 29/08; H04W 4/16

(52) U.S. Cl. CPC H04M 7/129; H04W 4/16; H04L 67/26
USPC 455/414.1

(57) ABSTRACT

Methods and devices for establishing a call are provided by embodiments of the present disclosure. The method includes: receiving a call request sent from a user through a terminal device; determining push information corresponding to personalized information of the user; and sending the push information to the terminal device. The present disclosure is configured to send push information corresponding to personalized information to a user based on the personalized information of the user after the user initiates a call, thereby avoiding a waste of communication resources.

### CROSS-REFERENCE TO RELATED APPLICATIONS

The present application is a Continuation-In-Part of International Application No. PCT/CN2013/083990, filed on Sep. 23, 2013, which is based on and claims priority to Chinese Patent Application No. 201210422368.8, filed on Oct. 29, 2012, the entire content of which is incorporated herein by reference.

### TECHNICAL FIELD

The present disclosure generally relates to the field of telecommunication, and more particularly, to methods and devices for establishing a call.

### BACKGROUND

As technology advances, there are more and more means of communication. A phone call, for example, typically consists of a caller and a callee. The caller is an originator of the call, and the callee is a recipient. When the caller makes a call, the callee usually due to various reasons cannot answer immediately, the call will typically be on hold for a period of time. In the related art, during this waiting time, a simple call tone, such as, a beep or a piece of music provided by an operator is fed back to the caller; an incoming call prompt is given in the telephone to the callee, and after the callee answers the call, then the call tone for the caller is stopped and the call is entered. The call tone heard by the caller before the call is connected is referred as a ringback tone. Generally, the ringback tone is a segment of sound transmitted through a data network of a telecommunication operator. Technically speaking, the ringback tone may be arbitrarily selected, for example, from a piece of music stored on a terminal device or over a network, or even a video or an animation. Although the duration of the ringback tone varies with different calling periods, the ringback tone will generally sustain over the second-level of time duration, and is inevitable. Similarly, in other telecommunication means such as Voice over Internet Protocol, Instant Message (IM) and the likes, such a call waiting period similar to the ringback tone is also presented.

### SUMMARY

Methods and devices are provided by embodiments of the present disclosure, which can send push information corresponding to personalized information to a user based on the personalized information of the user after the user initiates a call, thereby avoiding a waste of communication resources.

According to a first aspect of embodiments of the present disclosure, there is provided a method for establishing a call, comprising: receiving a call request sent from a user through a terminal device; determining push information corresponding to personalized information of the user; and sending the push information to the terminal device.

According to a second aspect of embodiments of the present disclosure, there is provided a method for establishing a call to a call center, comprising: sending personalized information of a user to the call center; and receiving push information corresponding to the personalized information of the user sent from the call center after a call request is sent to the call center.

According to a third aspect of embodiments of the present disclosure, there is provided a base station for establishing a call, comprising: one or more processors; a memory for storing instructions executable by the one or more processors, wherein the one or more processors are configured to perform: receiving a call request sent from a user through a terminal device; determining push information corresponding to personalized information of the user; and sending the push information to the terminal device.

According to a fourth aspect of embodiments of the present disclosure, there is provided a terminal device for establishing a call to a call center, comprises: one or more processors; a memory for storing instructions executable by the one or more processors, wherein the one or more processors are configured to perform: sending personalized information of a user to the call center; and receiving push information corresponding to the personalized information of the user sent from the call center after a call request is sent to the call center.

It is to be understood that both the foregoing general description and the following detailed description are exemplary only and are not restrictive of the present disclosure.

Therefore, in the present disclosure, the push information is customized in respect to personalized information of the user, and the push information is sent to the user after the user initiates a call request. Thus, communication resources and time resources during the call waiting period are effectively utilized, thereby avoiding a waste of communication resources.

### BRIEF DESCRIPTION OF THE DRAWINGS

FIG. 1 is an exemplary flow chart of a method for establishing a call according to an embodiment of the present disclosure;

FIG. 2 is an exemplary flow chart of another method for establishing a call according to an embodiment of the present disclosure;

FIG. 3 is an exemplary flow chart of a method for establishing a call according to a specific embodiment of the present disclosure;

FIG. 4 is an exemplary flow chart of another method for establishing a call according to a specific embodiment of the present disclosure;

FIG. 5 is a block diagram illustrating an apparatus for establishing a call according to the present disclosure;

FIG. 6 is another block diagram illustrating an apparatus for establishing a call according to the present disclosure;

FIG. 7 is another block diagram illustrating an apparatus for establishing a call according to the present disclosure;

FIG. 8 is a block diagram illustrating another apparatus for establishing a call according to the present disclosure;

FIG. 9 is a block diagram of a terminal device for establishing a call according to an exemplary embodiment; and

FIG. 10 is a block diagram of a base station for establishing a call according to an exemplary embodiment.

Through the above accompany drawings, the specific embodiments of the disclosure have been shown, for which a more detailed description will be given as below. These drawings and textual description are not intended to limit the scope of the concept of the disclosure in any manner, but to explain the concept of the disclosure to those skilled in the art through particular embodiments.

### DETAILED DESCRIPTION

In order to make the purposes, the technical solutions and the advantages of the present disclosure more apparent, the present disclosure will be further described in detail with reference to the accompanying drawings. It is apparent that the described embodiments are only a part of embodiments of the present disclosure, but not all the embodiments. Based on the embodiments in the present disclosure, all the other embodiments obtained by the person skilled in the art without inventive labor will fall within the protection scope of the present disclosure.

Methods, apparatuses and devices for establishing a call are provided by embodiments of the present disclosure, which are provided to send push information corresponding to personalized information to a user based on the personalized information of the user after the user initiates a call, thereby avoiding a waste of communication resources.

Referring to FIG. 1, a method for establishing a call at a call center (such as a base station) is provided by an embodiment of the present disclosure. The method includes the following steps.

In S101, a call request sent from a user through a terminal device is received. In this case, the user for sending the call request is the caller.

In S102, push information corresponding to personalized information of the user is determined.

In S103, the push information is sent to the terminal device.

For example, the step S102 of determining push information corresponding to personalized information of the user is performed in the following manner: personalized information of the user is acquired; and push information corresponding to the personalized information of the user is selected according to the acquired personalized information of the user.

Moreover, for example, push information that may be sent or interacted during the call waiting period may be stored in the call center in advance.

Moreover, for example, the personalized information of the user includes geographical location information of the terminal device, and/or type information of desired push information preset by the user. If the terminal device is a mobile terminal (such as a mobile phone), its geographical location information may be obtained through a GPS (Global Positioning System), or a base station positioning function carried by the terminal device. The geographical location information needs to be reported to a service provider by the mobile terminal, and the base station may determine and send push information corresponding to the geographical location information to the terminal device. The user may preset the type information for his desired push information in advance, so that the preset type information may also be used as a kind of personalized information to determine the push information to be sent to the terminal device. The above two kinds of personalized information may also be used at the same time. In case where neither of the above two kinds of personalized information can be acquired from the user, or in case where push information cannot be selected according to the acquired personalized information, the push information to be sent to the terminal device is determined by a default way.

Moreover, if a plurality of pieces of push information is determined at the base station, the plurality of pieces of push information may be sent to the terminal device by the base station according to priorities, or may be sent in a random manner.

Obviously, in S103, the push information will override an original response during the call waiting period. For example, it will override a ringback tone set by the caller through the Mobile Communication.

For example, if a callee is called by the call request through a preset number, the sending the push information to the terminal device may be performed in the following manner that: a call with the terminal device is established, and the push information is sent to the terminal device during the call. For example, upon receiving a request for terminating the call sent from the user through the terminal device, it is stopped sending the push information to the terminal device.

For example, sending the push information to the terminal device may be performed in the following manner: the push information is sent to the terminal device as a ringback tone before an indication of accepting the call request sent from the callee of the call request is received. For example, after the push information is sent to the terminal device, the method further includes: upon receiving a connection response sent from the callee of the call request, it is stopped sending the push information to the terminal device, and a call between the terminal device and the callee is established.

For example, the push information includes but not limited to: audio information, picture information, video information and even text messages. Format of the push information depends on the application scenario. For example, for voice call such as ordinary mobile phone calls and landline telephone calls, only audio information such as self-selected ringback tone and voice introduction of products may be adopted. For software calls such as 3rd-Generation (referred to as 3G) video calls, IM and Voice over Internet Protocol, audio information or video information, even picture information may be adopted. Moreover, when the network is not in a good condition, format of information with a low request for the network is selected as possible as it can be. Obviously, the IM includes, in addition to IM software at a conventional Personal Computer (referred to as PC), IM software at a mobile terminal, particularly IM software that is capable of sending short voice messages and performing real-time call through network traffic.

For example, contents of the push information include but not limited to: music, introduction of products, activity information, introduction of geography, and the like.

Moreover, for example, according to a demand of the terminal device, the base station may receive a feedback from the terminal device and conduct a corresponding processing on the feedback while the push information is sent, to provide an interactive service.

Moreover, for example, if the push information that needs to be sent is irrelevant to variable parameters such as the geographical location of the terminal device, S102 may be performed firstly, and S101 is then performed, to improve the efficiency of sending the push information.

Moreover, for example, parameters such as reading time of respective push information that have been sent, feedback of the user are statistically collected, to determine the sending effect of the push information.

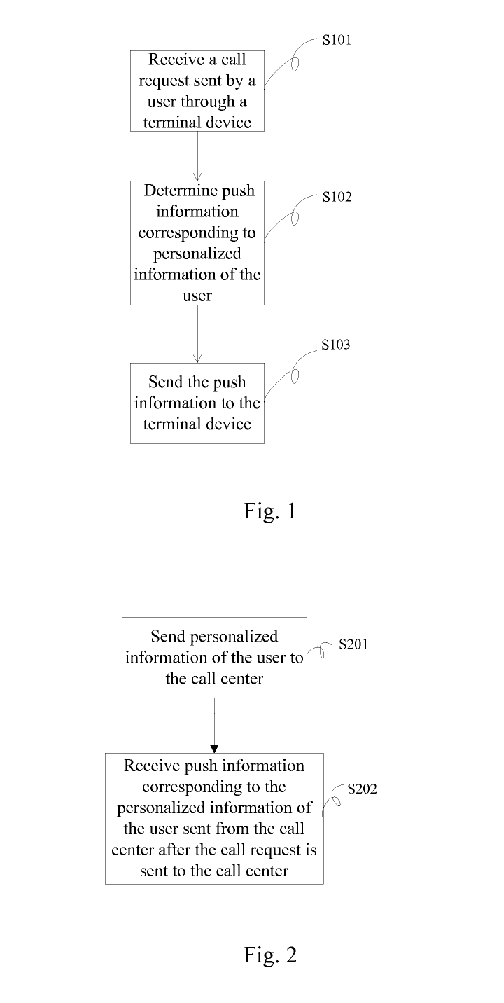

Referring to FIG. 2, a method for establishing a call at a terminal device is provided by an embodiment of the present disclosure. The method includes the following steps.

In S201, personalized information of the user is sent to the call center.

In S202, after the call request is sent to the call center, push information corresponding to the personalized information of the user sent from the call center is received.

For example, the personalized information of the user includes geographical location information of the terminal device and/or type information of desired push information preset by the user.

For example, the push information includes one or more kinds of the following information: audio information, picture information and video information.

Exemplary embodiments of the present disclosure are further given as follows.

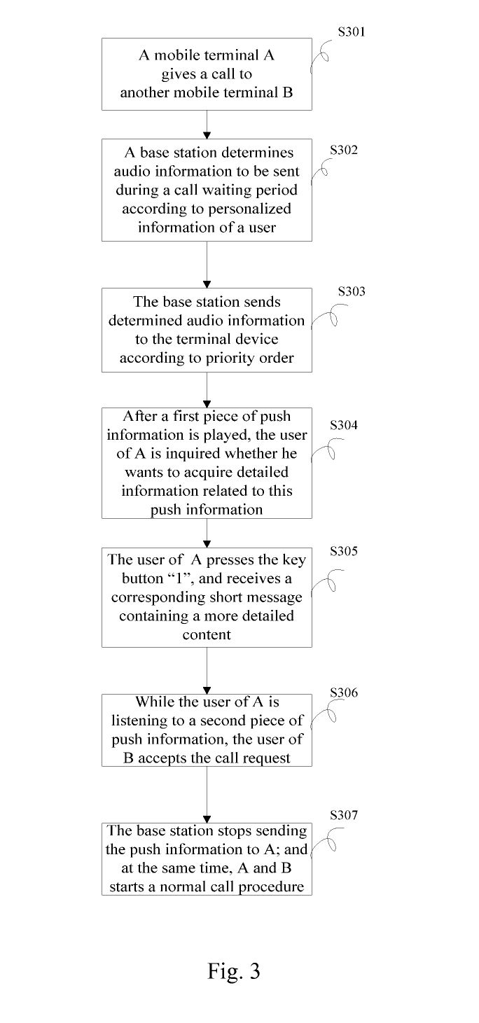

Referring to FIG. 3, taking mobile terminals as an example, a process of establishing a call includes the following steps.

In S301, a mobile terminal A gives a call to another mobile terminal B.

In S302, a base station determines audio information to be sent during a call waiting period according to personalized information of a user. For example, if A is located in a scenery area, voice introduction to the scenery area is sent to A. In another example, if it is determined that type information of desired push information preset by A is “sports”, sports news information is played to A.

For example, the personalized information of the user includes geographical location information and/or type information of desired push information preset by the user.

If the personalized information of the user is geographical location information, before the step S302, the process also includes a step of acquiring the geographical location information of the user by the base station.

For example, the base station may acquire the geographical location information of the user by receiving the geographical location information from the terminal device itself. In another example, the base station may acquire the geographical location information of the user by determining the location of the terminal device through a mobile network.

In S303, the base station sends the determined a plurality of audio information to the terminal device according to priority order of the audio information.

For example, a plurality of piece of push information may be determined according to personalized information of the user. For example, when the user is located in a business area, advertisement information of a plurality of merchants may be pushed to the user, and the advertisement information may be prioritized by the advertisement fee rates of the plurality of merchants.

In S304, after a first piece of push information is played, the user of the mobile terminal A is inquired whether it wants to acquire detailed information related to this push information. The user will be informed that the key button “1” should be clicked if he want to acquire detailed information and the key button “0” should be clicked if not.

In S305, the user of the mobile terminal A presses the key button “1”, and receives a corresponding short message containing a more detailed content.

In S306, while the user of the mobile terminal A is listening to a second piece of push information, the user of the mobile terminal B accepts the call request.

In S307, the base station stops sending the push information to A. At the same time, A and B starts a normal call procedure.

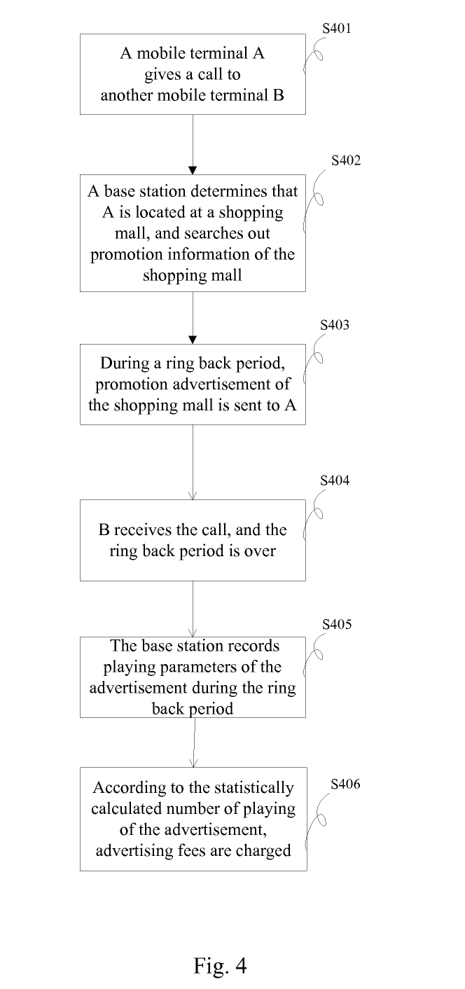

Referring to FIG. 4, another exemplary process of establishing a call includes the following steps.

In S401, a mobile terminal A gives a call to another mobile terminal B.

In S402, a base station determines that A is located at a shopping mall, and searches out promotion information of the shopping mall.

In S403, during a ring back period, promotion advertisement of the shopping mall is sent to A.

In S404, B receives the call, and the ring back period is over.

In S405, the base station records playing parameters of the advertisement during the ring back period.

In S406, according to the statistically calculated number of playing of the advertisement, advertising fees are charged to the merchants of the shopping mall.

For example, the base station may also calculate advertising fees in manners such as recording playing duration time of the advertisement and the like.

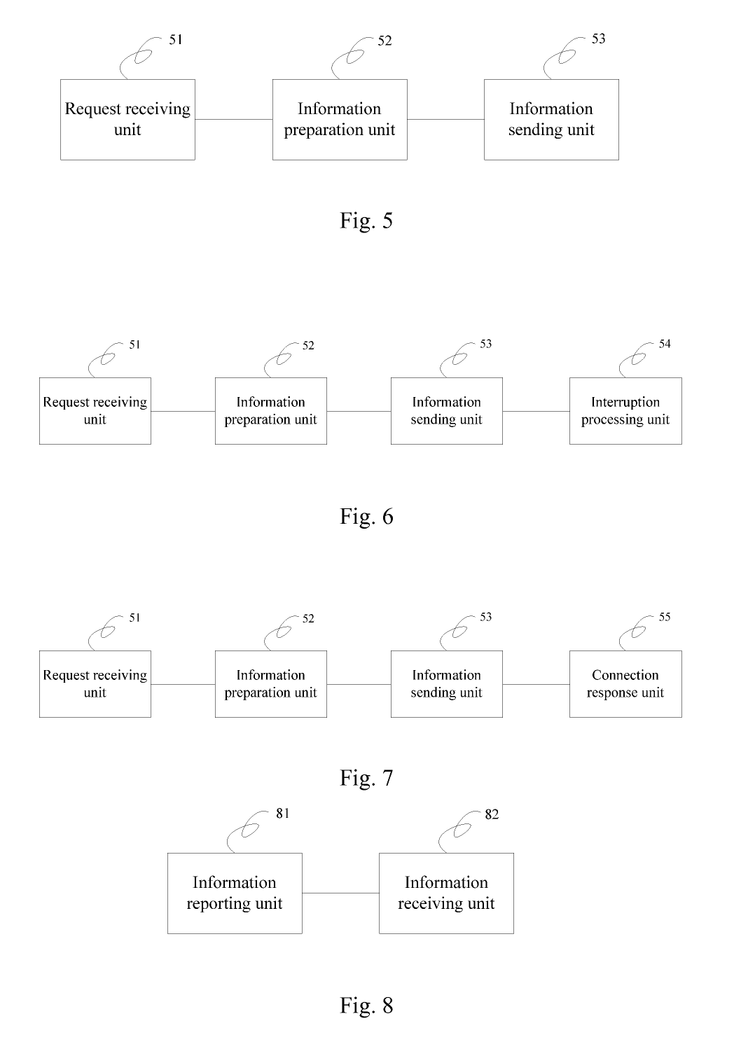

Referring to FIG. 5, an apparatus for establishing a call at the base station is provided by the present disclosure, including: a request receiving unit 51 configured to receive a call request sent from a user through a terminal device; an information preparation unit 52 configured to determine push information corresponding to personalized information of the user; and an information sending unit 53 configured to send the push information to the terminal device.

For example, the information preparation unit 52 is configured to acquire personalized information of the user and select push information corresponding to the personalized information of the user according to the personalized information of the user.

For example, the personalized information of the user includes geographical location information and/or type information of push information preset by the user.

For example, if a callee is called by the call request through a preset number, the information sending unit 53 is configured to establish a call with the terminal device, and send the push information to the terminal device during the call.

Referring to FIG. 6, For example, the apparatus also includes: an interruption processing unit 54 configured to stop sending the push information to the terminal device upon receiving a request for terminating the call sent from the user through the terminal device.

For example, the information sending unit 53 is also configured to: send the push information to the terminal device as a ringback tone before an indication of accepting the call request sent from the callee of the call request is received.

Referring to FIG. 7, For example, the apparatus also includes a connection response unit 55, which is configured to stop sending the push information to the terminal device, and establish a call between the terminal device and the callee, upon receiving a connection response sent from the callee of the call request.

For example, the push information includes one or more kinds of the following information: audio information, picture information and video information.

Referring to FIG. 8, an apparatus for establishing a call at the terminal device is provided by the present disclosure, including the following units: an information reporting unit 81 is configured to send personalized information of a user to a call center; and an information receiving unit 82 is configured to receive push information corresponding to the personalized information of the user sent from the call center after a call request is sent to the call center.

For example, the personalized information of the user includes geographical location information and/or type information of desired push information preset by the user.

For example, the push information includes one or more kinds of the following information: audio information, picture information and video information.

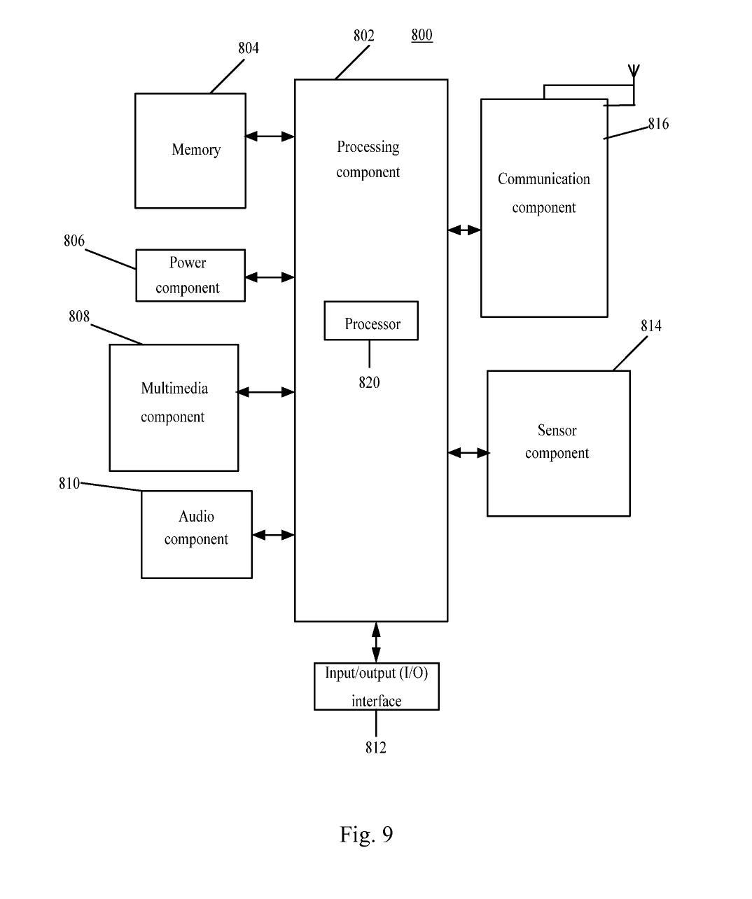

FIG. 9 is a block diagram of a terminal device 800 for establishing a call according to an exemplary embodiment. For example, the terminal device 800 may be a mobile phone, a computer, a digital broadcast terminal, a messaging device, a gaming console, a tablet, a medical device, exercise equipment, a personal digital assistant, and the like.

Referring to FIG. 9, the terminal device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal device 800. Examples of such data include instructions for any applications or methods operated on the terminal device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal device 800. The power component 806 may include a power management system, one or more power sources, and any other components associated with the generation, management, and distribution of power in the terminal device 800.

The multimedia component 808 includes a screen providing an output interface between the terminal device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the terminal device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal device 800. For instance, the sensor component 814 may detect an open/closed status of the terminal device 800, relative positioning of components, e.g., the display and the keypad, of the terminal device 800, a change in position of the terminal device 800 or a component of the terminal device 800, a presence or absence of user contact with the terminal device 800, an orientation or an acceleration/deceleration of the terminal device 800, and a change in temperature of the terminal device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal device 800 and other devices. The terminal device 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the terminal device 800, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium, when instructions in the storage medium are executed by the processor of the terminal device, the terminal device can execute a method for establishing a call to a call center, the method includes: sending personalized information of a user to the call center; and receiving push information corresponding to the personalized information of the user sent from the call center after a call request is sent to the call center.

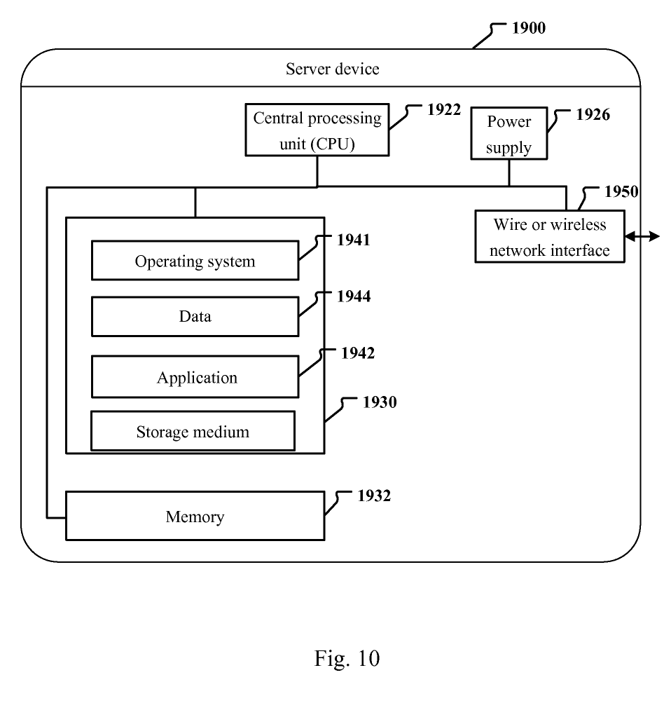

FIG. 10 is a structure diagram of a base station in the embodiments of the present disclosure. For example, a base station 1900 may very significantly due to different configurations and performances, and may include one or more central processing units (CPU) 1922 (such as one or more processors) and a memory 1932, one or more storage mediums 1930 (such as one or more mass-storage devices) for storing applications 1942 or data 1944. The memory 1932 and the storage medium 1930 may be may be a transient or a persistent storage. Programs stored in the storage medium 1930 may include one or more modules (not shown in the drawings), and each module may include a series of instruction operations in a terminal device. Further, the CPU 1922 may be provided to communicate with the storage medium 1930, and execute on the base station 1900 a series of instruction operations in the storage medium 1930.

The base station 1900 may also includes one or more power supplies 1926, one or more wire or wireless network interfaces 1950 and/or one or more operating systems 1941, such as Windows Server™, Mac OS X™, Unix™, Linux™, FreeBSD™, or the like.

In exemplary embodiments, there is also provided a non-transitory computer readable storage medium including instructions, such as included in the memory 1932 or storage medium 1930, which may be executed by the processor 1922 in the base station so as to perform the above-described methods. For example, the non-transitory computer-readable storage medium may be a ROM, a random access memory (RAM), a CD-ROM, a magnetic tape, a floppy disc, an optical data storage device, and the like.

A non-transitory computer readable storage medium, when instructions in the storage medium are executed by the processor of the base station, the base station can execute a method for establishing a call, the method includes: receiving a call request sent from a user through a terminal device; determining push information corresponding to personalized information of the user; and sending the push information to the terminal device.

It should be understood by those skilled in the art, that the embodiments of this disclosure may be provided as methods, systems or computer program products. Therefore, the disclosure may adopt embodiments in forms of hardware only, software only, or a combination of software and hardware. Furthermore, the disclosure may adopt forms of computer program products executable on one or more computer usable storage media (including but not being limited to disk storage and optical storage, etc.) containing computer usable program codes.

The disclosure is described in reference to the method, the device (system) and the flowchart and/or a block diagram of a computer program product according to the embodiments of the disclosure. It should be understood that each process and/or block in the flowcharts and/or block diagrams, and combinations of processes and/or blocks in the flowcharts and/or block diagrams, may be realized by computer program instructions. These computer program instructions may be provided to a generate-purpose computer, a special-purpose computer, an embedded processor, or processors of other programmable data processing devices, to create a machine, such that a device for realizing functions designated in one or more processes in the flowcharts and/or in one or more blocks in the block diagrams, may be created by instructions performed by a computer or processors of other programmable data processing devices.

These computer program instructions may further be stored in a computer readable storage that can boot a computer or other programmable data processing devices to work in a specific way, such that a manufactured goods including an instruction device may be created by the instructions stored in the said computer readable storage, and the said instruction device realizes the functions designated in one or more processes in the flowcharts and/or in one or more blocks in the block diagrams.

These computer program instructions may further be loaded into a computer or other programmable data processing devices, such that a series of operating steps may be performed on the computer or other programmable data processing devices, so as to generate processes realized by the computer, such that steps for realizing the functions designated in one or more processes in the flowcharts and/or in one or more blocks in the block diagrams may be provided by the instructions executable on the computer or other programmable data processing devices.

Apparently, those skilled in the art may make various modifications and variations to the disclosure without departing the spirit and scope of the disclosure. Thus, the disclosure intends to include these modifications and variations if they belong to the scope of the claims of the disclosure and the equivalent technology thereof

What is claimed is:

1. A method for establishing a call, comprising:
receiving a call request sent from a user through a terminal device;
determining push information corresponding to personalized information of the user; and
sending the push information to the terminal device.

2. The method of claim 1, wherein determining the push information corresponding to the personalized information of the user comprises:
acquiring the personalized information of the user; and
selecting the push information according to the acquired personalized information of the user.

3. The method of claim 2, wherein the personalized information of the user comprises:
geographical location information and/or type information of desired push information preset by the user.

4. The method of claim 1, wherein if a contact of a callee of the call request is a preset number, sending the push information to the terminal device comprises:
establishing a call with the terminal device; and
sending the push information to the terminal device during the call.

5. The method of claim 4, wherein after the push information is sent to the terminal device, the method further comprises:
stopping sending the push information to the terminal device upon receiving a request for terminating the call sent from the user through the terminal device.

6. The method of claim 1, wherein sending the push information to the terminal device comprises:
sending the push information to the terminal device as a ringback tone before receiving an indication of accepting the call request sent by the callee of the call request.

7. The method of claim 6, wherein after sending the push information to the terminal device, the method further comprises:
stopping sending the push information to the terminal device; and
establishing a call between the terminal device and the callee, upon receiving a connection response sent by the callee of the call request.

8. The method of claim 7, wherein the push information comprises one or more types of audio information, picture information and video information.

9. A method for establishing a call to a call center, comprising:
sending personalized information of a user to the call center; and
receiving push information corresponding to the personalized information of the user sent from the call center after a call request is sent to the call center.

10. The method of claim 9, wherein the personalized information of the user comprises: geographical location information and type information of desired push information preset by the user.

11. A base station for establishing a call, comprising:
one or more processors;
a memory for storing instructions executable by the one or more processors, wherein the one or more processors are configured to perform:
receiving a call request sent from a user through a terminal device;
determining push information corresponding to personalized information of the user; and
sending the push information to the terminal device.

12. The base station of claim 11, wherein determining the push information corresponding to the personalized information of the user comprises:
acquiring the personalized information of the user; and
selecting the push information according to the acquired personalized information of the user.

13. The base station of claim 12, wherein the personalized information of the user comprises:
geographical location information and/or type information of desired push information preset by the user.

14. The base station of claim 11, wherein if a contact of a callee of the call request is a preset number, sending the push information to the terminal device comprises:
establishing a call with the terminal device; and
sending the push information to the terminal device during the call.

15. The base station of claim 14, wherein after the push information is sent to the terminal device, the one or more processors are configured to further perform:
stopping sending the push information to the terminal device upon receiving a request for terminating the call sent from the user through the terminal device.

16. The base station of claim 11, wherein sending the push information to the terminal device comprises:
sending the push information to the terminal device as a ringback tone before receiving an indication of accepting the call request sent by the callee of the call request.

17. The base station of claim 16, wherein after sending the push information to the terminal device, the one or more processors are configured to further perform:
stopping sending the push information to the terminal device; and
establishing a call between the terminal device and the callee, upon receiving a connection response sent by the callee of the call request.

18. The base station of claim 17, wherein the push information comprises one or more types of audio information, picture information and video information.
